(19) United States
(12) Patent Application Publication
(10) Pub. No.: US 2011/0115211 A1
(43) Pub. Date: May 19, 2011

(54) SECURE DOCUMENT COMPRISING A NON-FORGEABLE INFORMATION TYPOGRAPHY

(75) Inventors: Patrick Feneyrou, Igny (FR); Grégoire Pillet, Paris (FR)

(73) Assignee: THALES, Neuilly Sur Seine (FR)

(21) Appl. No.: 13/054,140

(22) PCT Filed: Jul. 15, 2009
(86) PCT No.: PCT/EP2009/059044

§ 371 Date: Jan. 14, 2011

(30) Foreign Application Priority Data
Jul. 18, 2008 (FR) 0804113

(51) Int. Cl. B42D 15/00

(52) U.S. Cl. 283/74

(57) ABSTRACT

The invention relates to a secure document including at least one inscription layer having identity information inscribed in or on the inscription layer. The inscribed identity information is coded according to a type of code such that the inscribed identity information includes a first series of first characters and/or first images made redundant with a second series of second characters and/or second images said to be non-forgeable, a second character and/or a second image not being able to be converted into another second character and/or a second image without erasing at least some of the identity inscriptions.

The field of the invention is that of secure identity documents and notably passports or identity cards that have been made non-forgeable.

One of the technologies for producing identity documents entails using the laser marking of a polymer layer. The polymer, which may be, for example, PVC or, more commonly, polycarbonate, is generally doped to lower the laser writing threshold and, if necessary, modify the color of the laser etching.

The doping of the sensitive layer can be produced using pigments: the polymer is then burned in the vicinity of the pigment. The doping may also be done by particles (usually particles of Sb₂O₃ and of mica) dispersed in the polymer layer as close as possible to the core of the secure document: in this case, the particles turn black but not the polymer.

A second layer of undoped polymer usually covers the doped layer and provides a protection function and the smooth appearance of the card. Above a certain deposited energy density, the protection layer becomes damaged which results in visible surface destruction (matte appearance and tactile).

The marking is usually produced using one of the harmonics of an Nd:YAG laser (1064 nm, 532 nm or 355 nm). The lasers used industrially for this application are sources that are axially pumped by diodes. When combined with galvanometric mirrors, they can be used to inscribe any type of information on a card: photographs can be etched, in gray level, in typical resolutions of 300 to 900 dpi (dots per inch); the text can be etched in tactile or non-tactile writing. The powers involved for pulses at speeds of the order of a nanosecond are around 0.1 J cm⁻².

Given the available laser sources, such an energy density is accessible to a forger who could then convert the characters (for example, convert a “3” into an “8”, a “c” into an “o”, and so on) or add to them, mainly at the start and end of a name. Similarly, photographs can be altered by adding elements such as a beard, more hair, etc.

While numerous other security elements are used on an identity card (dichroic ink, personalized or non-personalized hologram, electronic chip, MLI/CLI surface array or lens technology respectively corresponding to “multiple laser image (or imaging)” and “changeable laser image (or imaging)”), it therefore seems simple to modify drawings, photographs or characters on cards inscribed by laser etching.

Numerous security solutions exist on these identity cards, for preventing the re-writing or modifying of letters or photographs by laser and are notably described in the patents U.S. Pat. No. 4,234,214 and EP 1 935 664. These solutions are based on a common principle, the secure information is inscribed both in positive and in negative and modifying the information entails simultaneously removing and adding inscription. Since the removal of inscription is generally more complex to do, the document is thus secure. Checking the validity of the document therefore entails comparing the two inscriptions (positive and negative).

In the case of a double inscription in positive and negative, it is usually preferable for the two inscriptions (positive and negative) to be of the same size and close together in order to make it easy to compare the two inscriptions. In this case, it is obvious that these solutions impair the general legibility and the esthetics of the document (important in the case of documents intended for the general public). The other coding examples generally also exhibit reduced legibility and esthetics compared to a document that does not use coding.

This is why the present invention proposes that the identity information should be inscribed at least twice. At least one of the versions must use a coding solution that makes it possible to avoid the forging of documents by modifying drawings, photographs or character(s) (letter(s) or digit(s)) or the addition of additional letter(s) and by extension a secure document making forging by invisible rewriting impossible.

More specifically, the subject of the invention is a secure document including at least one inscription layer comprising identity information inscribed in or on said layer, characterized in that the inscribed identity information is coded according to a type of code such that said inscribed identity information comprises a first series of first characters and/or first images made redundant with a second series of second characters and/or second images said to be non-forgeable, a second character and/or a second image not being able to be converted into another second character and/or a second image without erasing at least some of the identity inscriptions.

According to a variant of the invention, the information linked to the first series is separated by lines from the other information.

According to a variant of the invention, the information linked to the first series is not written on the same side as the information linked to the second series.

According to a variant of the invention, the coded information contains images.

According to a variant of the invention, the coded information contains typographic characters.

According to a variant of the invention, the information linked to the first series is not of the same size/resolution as the information linked to the second series.

According to a variant of the invention, the information linked to the second series contains less detail than the information linked to the first series.

According to a variant of the invention, the information linked to the first series contains an image.

According to a variant of the invention, the information linked to the second series contains an image.

According to a variant of the invention, the information linked to the first series and that linked to the second series contains an image, one being in color and the other being in black and white.

According to a variant of the invention, the coding used in the second series relies on the redundant use of a positive and negative inscription of the same information.

According to a variant of the invention, the coding used for the second series relies on the use of a permutation or a combination associated with a permutation of the colors that make up the first image.

According to a variant of the invention, the first characters belong to a first alphabet, the second characters belonging to a second alphabet.

Advantageously, the first alphabet is the Latin alphabet, the second alphabet being the military alphabet made up of words.

According to a variant of the invention, the inscribed identity information has a number of different inscription sizes and/or resolutions.

According to a variant of the invention, the type of code for the second characters is a typography comprising a character font such that a character cannot be converted into another character by additional inscription, the characters defining a simply connected surface area.

According to a variant of the invention, the type of code for the second characters is a typography comprising a character font such that a character cannot be converted into another character by additional inscription, the typography comprising elements of accent, period, cedilla and other such types that are continuous relative to the body of a letter to which said element is attached.

According to a variant of the invention, the typography comprises characters complemented by boundaries.

According to a variant of the invention, the characters are framed by continuous or discontinuous boundaries.

According to a variant of the invention, the identity information is inscribed by etching into the inscription layer.

According to a variant of the invention, the identity information is inscribed with indelible ink.

According to a variant of the invention, the identity information is inscribed by partial destruction of the inscription layer.

The invention will be better understood and other advantages will become apparent from reading the following description given as a nonlimiting example and by virtue of the appended figures in which:

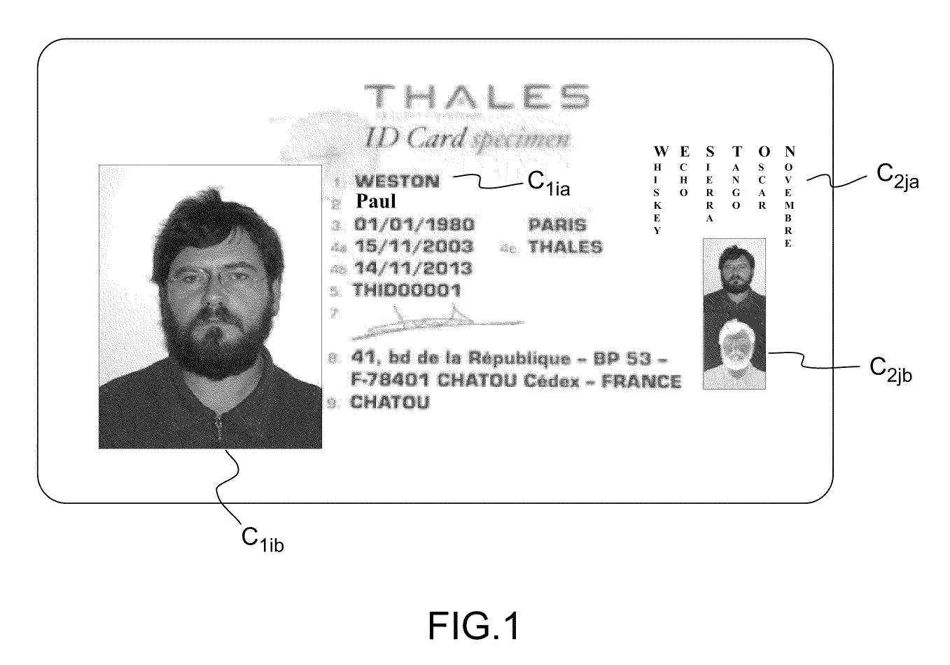

FIG. 1 illustrates a coding variant used in a document according to the invention, comprising letter inscriptions made redundant by word inscriptions;

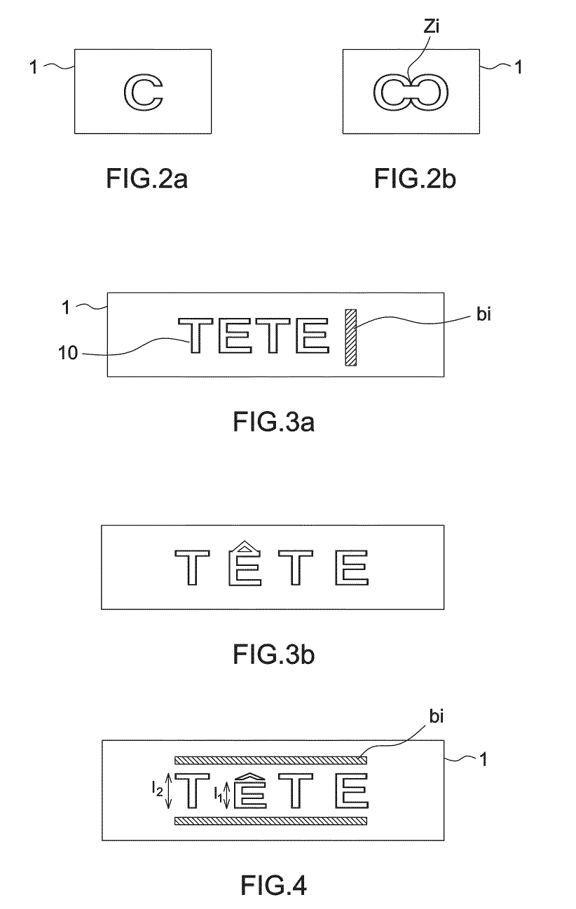

FIGS. 2a and 2b illustrate a variant document according to the invention, comprising characters defining a simply connected surface area;

FIGS. 3a and 3b illustrate a variant document according to the invention, comprising characters defining a simply connected surface area incorporating punctuation or accent elements or boundaries;

FIG. 4 illustrates a variant document according to the invention, comprising characters of different sizes.

According to the invention, the secure document includes at least one inscription layer in or on which identity information is inscribed.

Such information may be text, typically relating to civil status information for example when the secure document is an identity card or a passport.

The inscription can be produced equally by conventional ink inscription techniques and by etching (laser for example) causing the inscription layer to be locally burned or modified.

It is also possible to inscribe information by using a photosensitive layer which may reveal information under the action of an optical beam with an appropriate wavelength.

Thus, the present invention will be described hereinbelow in the context of inscriptions etched for example by laser but could equally be described with other inscription modes.

By convention, when the identity inscriptions relate to text, digits, symbols, etc, the issue will be inscription typography, regardless of the selected inscription mode.

To counter the possibility of document forging by modifying inscriptions which may typically be images, letters or digits, while using standard inscription methods, not requiring any modification of used blank card or passport type documents or modification of industrial inscription machines, the secure document 1 can advantageously, according to a first variant illustrated in FIG. 1, include a first series of characters C1i of alphabet letter type, made redundant by a second series of second characters C2j consisting, for example, of words. For this, it will advantageously be possible to use the so-called “military” alphabet, the correlation of which with the alphabet is given in the table below.

| A | B | C | D | E | F | G | H | I |
|---|---|---|---|---|---|---|---|---|
| Alpha | Bravo | Charlie | Delta | Echo | Foxtrot | Golf | Hotel | India |

| J | K | L | M | N | O | P | Q | R |
|---|---|---|---|---|---|---|---|---|
| Juliet | Kilo | Lima | Mike | November | Oscar | Papa | Quebec | Romeo |

| S | T | U | V | W | X | Y | Z |
|---|---|---|---|---|---|---|---|
| Sierra | Tango | Uni- | Victor | Whiskey | X-Ray | Yankee | Zulu |
| | | form | | | | | |

According to this variant, one and the same word is inscribed both with the first characters C1ia and with the second characters C2ja. Moreover, the identity of the person is also reinforced with a color portrait image C1ib, made redundant by two small portrait images C2jb.

It may also be advantageous to lock, in the best way possible, any intermediate area by also etching an element with which to seal the area containing the initial information.

This can be done, for example, by an additional black character on either side of this information.

It would equally be possible to envisage introducing framing-type boundaries for such information, these boundaries being able either to be inscribed by burning or to be pre-inscribed on the blank medium.

The comparison of the two positive and negative inscriptions then makes it impossible to modify or add a letter.

In practice, this would necessarily entail bleaching out a laser-etched area (either on the positive inscription or on the negative inscription).

For example, an “o” could be converted into a “c” on the negative part but not on the positive part.

A character font that is particularly well suited to the inventive secure document is a font that cannot be forged simply by adding black or simply by adding white.

Typically, a character font having a continuous contour and an intermediate white area fulfills this condition.

This is a font comprising characters defining a simply connected surface area, for which the addition of inscription is made necessarily visible as represented in FIGS. 2a and 2b. It is a character font that has a contour and a continuous intermediate white area with which to fulfill this condition.

Typically, the complement of a “3” cannot result in an “8”, similarly, a “C” could not be converted into “O” since such forging would necessarily introduce a modification to the chosen character font with an apparent delimitation as illustrated by the area zi of FIG. 2b.

An alternative to this type of font, which is sufficient in itself to fulfill the necessary condition of not being able to be forged by the addition of black, is to complement a given font by the use of boundaries.

Thus, it is also suitable to bound a word as is shown by the exemplary inscription illustrated in FIG. 3a, in which a word is bounded by the addition of a symbol that cannot be converted into a character of the alphabet by the addition of black. Typically, a vertical boundary size bi that is big enough relative to the use of an alphabet character size may be suitable. It would equally be possible to envisage a white boundary delimited by a black region.

It may in this case be useful to include continuous accentuation relative to the body of the letter as illustrated in FIG. 3b. Thus, a typography in which only one alphabet is used and which does not incorporate accents could not meet the conditions of the present invention.

Similarly, horizontal boundaries may be used to lock the conversion of characters that could be complemented with accents, dots, cedillas, etc.

In this case, it may be particularly advantageous to use two sizes of characters of length 11 and 12 if said characters require the addition of a dot, an accent or a cedilla as illustrated in FIG. 4 which shows a combination of the use of horizontal boundaries bj and of different character sizes.

1. A secure document comprising at least one inscription layer comprising identity information inscribed in or on said layer, wherein the inscribed identity information is coded according to a type of code such that said inscribed identity information comprises one of a first series of first characters and first images made redundant with one of a second series of second characters and second images said to be non-forgeable, one of a second character and a second image not being able to be converted into one of another second character and a second image without erasing at least some of the identity inscriptions.

2. The secure document as claimed in claim 1, wherein the information linked to the first series is separated by lines from the other information.

3. The secure document as claimed in claim 1, wherein the information linked to the first series is not written on the same side as the information linked to the second series.

4. The secure document as claimed in claim 1, wherein the coded information comprises images.

5. The secure document as claimed in claim 1, wherein the coded information comprises typographic characters.

6. The secure document as claimed in claim 1 wherein the information linked to the first series is not of the same size or resolution as the information linked to the second series.

7. The secure document as claimed in claim 1, wherein the information linked to the second series includes less detail than the information linked to the first series.

8. The secure document as claimed in claim 1, wherein the information linked to one of the first series and the second series comprises an image.

9. The secure document as claimed in claim 1, wherein the information linked to each of the first series and the second series comprises an image, one being in color and the other being in black and white.

10. The secure document as claimed in claim 1, wherein the coding used in the second series relies on the redundant use of a positive and negative inscription of the same information.

11. The secure document as claimed in claim 1, wherein the coding used for the second series relies on the use of a permutation or a combination associated with a permutation of the colors that make up the first image.

12. The secure document as claimed in claim 1, wherein the first characters belong to a first alphabet, and the second characters belong to a second alphabet.

13. The secure document as claimed in claim 12, wherein the first alphabet is the Latin alphabet, and the second alphabet is a military alphabet comprising words.

14. The secure document as claimed in claim 1, wherein the inscribed identity information has a number of different inscription sizes or inscription resolutions.

15. The secure document as claimed in claim 1, wherein the type of code for the second characters is a typography comprising a character font such that a character cannot be converted into another character by additional inscription, the characters defining a connected surface area.

16. The secure document as claimed in claim 15, wherein the type of code for the second characters is a typography comprising a character font such that a character cannot be converted into another character by additional inscription, the typography comprising elements of accent, period, cedilla and other types that are continuous relative to the body of a letter to which said element is attached.

17. The secure document as claimed in claim 16, wherein the typography comprises characters complemented by boundaries.

18. The secure document as claimed in claim 1, wherein the characters are framed by continuous or discontinuous boundaries.

19. The secure document as claimed in claim 1, wherein the identity information is inscribed by etching into the inscription layer.

20. The secure document as claimed in claim 1, wherein the identity information is inscribed with indelible ink.

21. The secure document as claimed in claim 1, wherein the identity information is inscribed by partial destruction of the inscription layer.

22. The secure document as claimed in claim 2, wherein the identity information is inscribed by etching into the inscription layer.

23. The secure document as claimed in claim 2, wherein the identity information is inscribed with indelible ink.

24. The secure document as claimed in claim 2, wherein the identity information is inscribed by partial destruction of the inscription layer.
